(19) United States
(12) Patent Application Publication
(10) Pub. No.: US 2006/0171542 A1
(43) Pub. Date: Aug. 3, 2006

(54) Coding of main and side signal representing a multichannel signal

(76) Inventors: Albertus Cornelis Den Brinker, Eindhoven (NL); Andreas Johannes Gerrits, Eindhoven (NL); Robert Johannes Sluijter, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,635

(22) PCT Filed: Mar. 18, 2004
(86) PCT No.: PCT/IB04/50288

§ 371 Date: Sep. 20, 2005

(30) Foreign Application Priority Data
Mar. 24, 2003 (EP) 03100752.9

(51) Int. Cl. H04R 5/00; H04R 29/00

(52) U.S. Cl. 381/23; 381/56

(57) ABSTRACT

The present invention relates to a method of encoding a main and a side signal that are generated by the first step of parametric stereo encoding. when encoding according to the present invention, firstly, the relation between the power spectral energies of the main and the side signal is kept intact per psycho acoustical band. Secondly, the side signal has to be uncorrelated with the main signal in psycho acoustical sense. the method of encoding the main and the side signal, according to the present invention, is twofold. Firstly, a filter is estimated which is able to re-instate the desired spectral amplitude relation and the temporal envelope.

### FIELD OF THE INVENTION

The present invention relates to coding a main and a side signal being the result of the first step of performing parametric coding of multichannel signals.

### BACKGROUND OF THE INVENTION

Stereophonic audio signals comprise a left (L) and a right (R) signal component which may originate from a stereo signal source, for example from separated microphones. The coding of audio signals aims at reducing the bit rate of a stereophonic signal, e.g. in order to allow an efficient transmission of sound signals via a communications network, such as the Internet, via a modem and via analogue telephone lines, mobile communication channels or via other wireless networks, etc., and in order to store a stereophonic sound signal on a chip card or another storage medium with limited storage capacity.

EP 1,107,232 discloses a method of performing parametric coding to generate a representation of a stereo audio signal, which is composed of a left channel signal and a right channel signal. To utilize transmission bandwidth efficiently, such a representation contains information concerning only one of the L and R signals, and parametric information based on which the other signal can be recovered. Because of the design of the parametric coding, the representation advantageously captures localization cues of the stereo audio signal, including intensity and phase characteristics of L and R. As a result, the stereo audio signal recovered from the transmitted representation affords a high stereo quality.

Even though parametric stereo encoding does improve the bit-rate utilisation, it is of interest to improve this utilisation by further reducing a required bit-rate for a given sound quality.

### OBJECT AND SUMMARY OF THE INVENTION

It is an object of the present invention to provide a solution to the above-mentioned problem.

The object of the present invention is solved by a method of encoding a main and a side signal, where at least said main and side signal represent a multichannel audio signal, where the main and the side signal have the properties that the relation between the power spectral energies of said main and side signal is intact per psycho-acoustical band and where said side signal is psycho acoustically uncorrelated with the main signal. The method of encoding the main and the side signal comprises the steps of:
transforming the side signal by a predetermined transformation into a set of transformation parameters, said parameters being adapted for reproducing a third signal corresponding to the side signal and having said properties of the side signal,
representing the multichannel signal at least by said main signal and by said transformation parameters.

Thereby the bit rate can be decreased when transmitting data and further, less storage space is needed when storing encoded data.

In an embodiment the predetermined transformation comprises the step of:
generating a set of transformation parameters from the main and the side signal, where said transformation parameters define the relationship between the spectra of the main and the side signal.

This is an efficient way of representing the essential information from the side signal.

In a specific embodiment the step of generating the transformation parameters comprises the steps of:
performing linear prediction on both said main signal and on said side signal resulting in two sets of prediction coefficients, a first set comprising coefficients corresponding to the main signal and a second set comprising coefficients corresponding to the side signal,
determining the energy of the side signal, said transformation parameters comprising said prediction coefficients and said determined energy.

Based on these transformation parameters the side signal can be reproduced very accurately.

In another embodiment the step of generating the transformation parameters comprises the steps of:
determining the amplitude spectra of the main and the side signal,
determining the ratios between the determined amplitude spectras of the main and the side signal,
generating prediction coefficients by using information based on the determined ratios as input to a prediction system,
determining the energy of the side signal, said transformation parameters comprising said prediction coefficients and said determined energy.

Then only one set of prediction coefficients is necessary which further decreases the necessary bit rate when transmitting the encoded signal.

In an embodiment the step of generating the transformation parameters comprises the steps of:
performing linear prediction on the side signal resulting in a set of prediction coefficients comprising coefficients corresponding to the side signal,
determining the temporal envelope for the side signal,
said transformation parameters comprising said prediction coefficients and said determined temporal envelope.

This is a very simple and thereby resource efficient method of generating transformation parameters.

In a specific embodiment transforming the side signal into a set of transformation parameters is performed on overlapping segments of at least the side signal and by determining transformation parameters corresponding to each segment. By segmenting before encoding the parameters only have to describe a few data, and based on the few parameters a more precise regeneration of the segment can be performed. Further, signal variations can easier be followed, just as encoding can be performed on segments of streaming data.

The invention further relates to a method for decoding which corresponds to the methods of encoding as described above. Accordingly, the same advantages apply.

The invention relates to a method of decoding main and side signal information, where at least said main and side signal represent a multichannel audio signal. The main and the side signal have the properties that the relation between the power spectral energies of said main and side signal is intact per psycho-acoustical band and where said side signal is psycho acoustically uncorrelated with the main signal, the method comprises the steps of:
receiving a main signal and a set of transformation parameters, said transformation parameters being adapted for reproducing a third signal corresponding to the side signal and having the same properties as the side signal,
generating the third signal having the said properties of the side signal by using said transformation parameters for inversely performing the predetermined transformation.

In an embodiment the step of generating the third signal comprises the steps of:
generating a white noise sequence,
generating a first signal by filtering the white noise sequence in a linear prediction filter defined by the prediction coefficient corresponding to the side signal, said prediction coefficients being comprised in the received transformation parameters,
attenuating the second signal until the energy of the second signal corresponds to the determined energy of the side signal, said determined energy being comprised in said received transformation parameters.

In a specific embodiment the step of generating the third signal comprises the steps of:
generating a temporal signal in which the spectral energy relation between the temporal signal and the main signal corresponds to the spectral energy relation between the main signal and the side signal, said temporal signal being generated by filtering the main signal using the transformation parameters as filter parameters,
filtering the temporal signal ensuring that the output signal is psycho acoustically uncorrelated with the main signal.

In a specific embodiment the step of generating the temporal signal comprises the steps of:
generating a first signal by filtering the main signal in a linear prediction analysis filter defined by the prediction coefficient corresponding to the main signal, said prediction coefficients being comprised in the received transformation parameters,
generating a second signal by filtering said first signal in a linear prediction synthesis filter defined by the prediction coefficients corresponding to the side signal comprised in the received transformation parameters,
attenuating the second signal until the energy of the signal corresponds to the determined energy of the side signal, said determined energy being comprised in said received transformation parameters.

In another embodiment the step of generating the temporal signal comprises the steps of:
generating a first signal by filtering the main signal in a linear prediction filter which is defined by the prediction coefficient, where said prediction coefficients are comprised in the transformation parameters, said prediction coefficients having been generated by
   determining the ratios between the determined amplitude spectras of the main and the side signal,
   performing an inverse Fourier transformation of the determined ratios,
   using the result of the inverse Fourier transformation as input to a prediction system.
   attenuating the second signal until the energy of the signal corresponds to the determined energy of the side signal, said determined energy being comprised in said transformation parameters.
      said transformation parameters comprising said prediction coefficients and said determined energy.

In another embodiment, when the transformation parameters have been generated corresponding to specific segments, the step of generating the third signal, having the same properties as the side signal, is performed by initially interpolating transformation parameters between the specific segments.

The present invention can be implemented in different ways e.g. through the methods described above. The following will describe arrangements for encoding and decoding multichannel signals, respectively a data signal and further product means, each yielding one or more of the benefits and advantages described in connection with the first-mentioned method, and each having one or more preferred embodiments corresponding to the preferred embodiments described in connection with the first-mentioned method and disclosed in the dependant claims.

It is noted that the features of the methods described above and in the following may be implemented in software and carried out in a data processing system or through other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

The invention further relates to an arrangement for encoding a main and a side signal, where at least said main and side signal represent a multichannel audio signal, where the main and side signal have the properties that the relation between the power spectral energies of said main and side signal is intact per psycho-acoustical band and where said side signal is psycho acoustically uncorrelated with the main signal, the arrangement comprising:
first processing means for transforming the side signal by a predetermined transformation into a set of transformation parameters, said parameters being adapted for reproducing a third signal corresponding to the side signal and having the same properties as the side signal,
second processing means adapted to represent the multichannel signal at least by said main signal and by said transformation parameters.

The invention further relates to an arrangement for decoding main and side signal information, where at least said main and side signal represents a multichannel audio signal, the main and side signal have the properties that the relation between the power spectral energies of said main and side signal is intact per psycho-acoustical band and where said side signal is psycho acoustically uncorrelated with the main signal, the method comprises the steps of:
receiving means for receiving a main signal and a set of transformation parameters, said transformation parameters being adapted for reproducing a third signal corresponding to the side signal and having the same properties as the side signal,
   processing means for generating the third signal having the same properties as the secondary signal by using said transformation parameters for inversely performing the predetermined transformation.

The above arrangements may be part of any electronic equipment including computers, such as stationary and portable PCs, stationary and portable radio communications equipment and other handheld or portable devices, such as mobile telephones, pagers, audio players, multimedia players, communicators, i.e. electronic organisers, smart phones, personal digital assistants (PDAs), handheld computers or the like.

The term processing means comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. The above first and second processing means may be separate processing means or they may be comprised in one processing means.

The term receiving means includes circuitry and/or devices suitable for enabling the communication of data, e.g. via a wired or a wireless data link. Examples of such receiving means include a network interface, a network card, a radio receiver, a receiver for other suitable electromagnetic signals, such as infrared light, e.g. via an IrDa port, radio-based communications, e.g. via Bluetooth transceivers or the like. Further examples of such receiving means include a cable modem, a telephone modem, an Integrated Services Digital Network (ISDN) adapter, a Digital Subscriber Line (DSL) adapter, a satellite transceiver, an Ethernet adapter or the like.

The term receiving means further comprises other input circuits/devices for receiving data signals, e.g. data signals stored on a computer-readable medium. Examples of such receiving means include a floppy-disk drive, a CD-Rom drive, a DVD drive, or any other suitable disc drive, a memory card adapter, a smart card adapter, etc.

### BRIEF DESCRIPTION OF THE DRAWINGS

In the following, preferred embodiments of the invention will be described referring to the figures, where

FIG. 1 shows a schematic view of a system for communicating stereo signals according to an embodiment of the invention;

FIG. 2 shows a schematic view of an arrangement for performing parametric encoding comprising a first and a second step;

FIG. 3 shows a schematic view of an arrangement for performing parametric decoding;

FIG. 4 shows the general idea of the second step of an encoder according to the present invention;

FIG. 5 shows the general idea of the second step of a decoder according to the present invention;

FIG. 6 shows a schematic view of an arrangement for the second step of encoding a stereo signal according to a first embodiment of the invention;

FIG. 7 shows a schematic view of an arrangement for decoding a stereo signal according to a first embodiment of the invention;

FIG. 8 shows a schematic view of an arrangement for the second step encoding a stereo signal according to a second embodiment of the invention;

FIG. 9 shows a schematic view of an arrangement for decoding a stereo signal according to a second embodiment of the invention;

FIG. 10 shows a schematic view of an arrangement for the second step of encoding a stereo signal according to a third embodiment of the invention;

FIG. 11 shows a schematic view of an arrangement for decoding a stereo signal according to the third embodiment of the invention.

### DESCRIPTION OF PREFERRED EMBODIMENTS

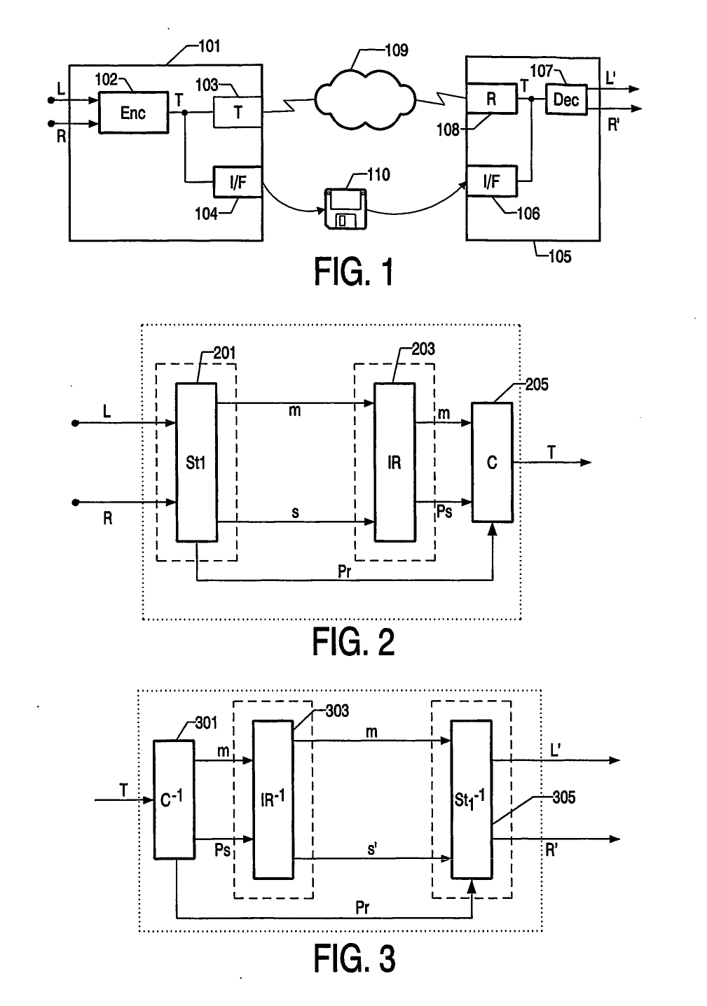

FIG. 1 shows a schematic view of a system for communicating stereo signals according to an embodiment of the invention. The system comprises a coding device 101 for generating a coded stereophonic signal and a decoding device 105 for decoding a received coded signal into a stereo L′ signal and a stereo R′ signal component. The coding device 101 and the decoding device 105 each may be any electronic equipment or part of such equipment. Here the term electronic equipment comprises computers, such as stationary and portable PCs, stationary and portable radio communication equipment and other handheld or portable devices, such as mobile telephones, pagers, audio players, multimedia players, communicators, i.e. electronic organisers, smart phones, personal digital assistants (PDAs), handheld computers or the like. It is noted that the coding device 101 and the decoding device may be combined in one electronic equipment where stereophonic signals are stored on a computer-readable medium for later reproduction.

The coding device 101 comprises an encoder 102 for encoding a stereophonic signal according to the invention, where the stereophonic signal includes an L signal component and an R signal component. The encoder receives the L and R signal components and generates a coded signal T. The stereophonic signal L and R may originate from a set of microphones, e.g. via further electronic equipment such as a mixing equipment, etc. The signals may further be received as an output from another stereo player, over-the-air as a radio signal, or by any other suitable means. Preferred embodiments of such an encoder, according to the invention, will be described below. According to one embodiment, the encoder 102 is connected to a transmitter 103 for transmitting the coded signal T via a communications channel 109 to the decoding device 105. The transmitter 103 may comprise circuitry suitable for enabling the communication of data, e.g. via a wired or a wireless data link 109. Examples of such a transmitter include a network interface, a network card, a radio transmitter, a transmitter for other suitable electromagnetic signals, such as an LED for transmitting infrared light, e.g. via an IrDa port, radio-based communications, e.g. via a Bluetooth transceiver or the like. Further examples of suitable transmitters include a cable modem, a telephone modem, an Integrated Services Digital Network (ISDN) adapter, a Digital Subscriber Line (DSL) adapter, a satellite transceiver, an Ethernet adapter or the like. Correspondingly, the communications channel 109 may be any suitable wired or wireless data link, for example of a packet-based communications network, such as the Internet or another TCP/IP network, a short-range communications link, such as an infrared link, a Bluetooth connection or another radio-based link. Further examples of the communications channel include computer networks and wireless telecommunications networks, such as a Cellular Digital Packet Data (CDPD) network, a Global System for Mobile (GSM) network, a Code Division Multiple Access (CDMA) network, a Time Division Multiple Access Network (TDMA), a General Packet Radio service (GPRS) network, a Third Generation network, such as a UMTS network, or the like. Alternatively, or additionally, the coding device may comprise one or more other interfaces 104 for communicating the coded stereo signal T to the decoding device 105.

Examples of such interfaces include a disc drive for storing data on a computer-readable medium 110, e.g. a floppy-disk drive, a read/write CD-ROM drive, a DVD-drive, etc. Other examples include a memory card slot, a magnetic card reader/writer, an interface for accessing a smart card, etc. Correspondingly, the decoding device 105 comprises a corresponding receiver 108 for receiving the signal transmitted by the transmitter and/or another interface 106 for receiving the coded stereo signal communicated via the interface 104 and the computer-readable medium 110. The decoding device further comprises a decoder 107 which receives the received signal T and decodes it into corresponding stereo components L′ and R′. Preferred embodiments of such a decoder, according to the invention, will be described below. The decoded signals L′ and R′ may subsequently be fed into a stereo player for reproduction via a set of speakers, head-phones or the like.

FIG. 2 shows a schematic view of the general idea of an encoder, according to the present invention, where the input is the L and R components and the output is T. In a first step 201, the L and R components are encoded using known parametric stereo coding resulting in a main signal m and a side signal s and side info Pr. In the second step 203, the relevant information of the secondary signal is captured in a parametric way represented by the parameters Ps such that at the decoder side, a psycho-acoustically identical secondary signal can be generated on the basis of the main signal and the parameters Ps. When the main signal and the parameters Ps are to be communicated as illustrated in FIG. 1, then the information is fed into a combiner 205. The combiner 205 performs framing, bit-rate allocation and lossless coding, resulting in a combined signal T to be communicated.

FIG. 3 shows a schematic view of the general idea of a decoder, according to the present invention, where a combined signal T is received, which i.e. could originate from the encoder as described in FIG. 2. The decoder comprises an extraction step 301 for extracting the encoded information m and Ps, i.e. an inverse operation of the combiner 205 is performed. First the extracted information is decoded in a decoder 303, where the decoding corresponds to the encoding performed by the second step 203 of FIG. 2, resulting in the decoded signals m and s′. Then the m and the s signal are decoded in a decoder 305, where the decoding corresponds to the encoding performed by the first step 201 of FIG. 2, resulting in the decoded components L′ and R′.

The main signal used in the decoder could either be the original m signal or a main signal which has been encoded/decoded by e.g. quantisation.

The main and the side signal that are generated by the first step of parametric stereo encoding, as described above, are characterised by the fact that the waveform of the main signal has to be kept intact, but the side signal is rather arbitrary in waveform and adheres to two conditions only. Firstly, the relation between the power spectral energies of the main and the side signal has to be kept intact per psycho acoustical band. Secondly, the side signal has to be uncorrelated with the main signal in psycho acoustical sense. The method of encoding the main and the side signal, according to the present invention, is twofold. Firstly, a filter is estimated which is able to re-instate the desired spectral amplitude relation and a temporal profile. Secondly, in specific embodiments, as described below, a filter is derived which guarantees the desired uncorrelatedness.

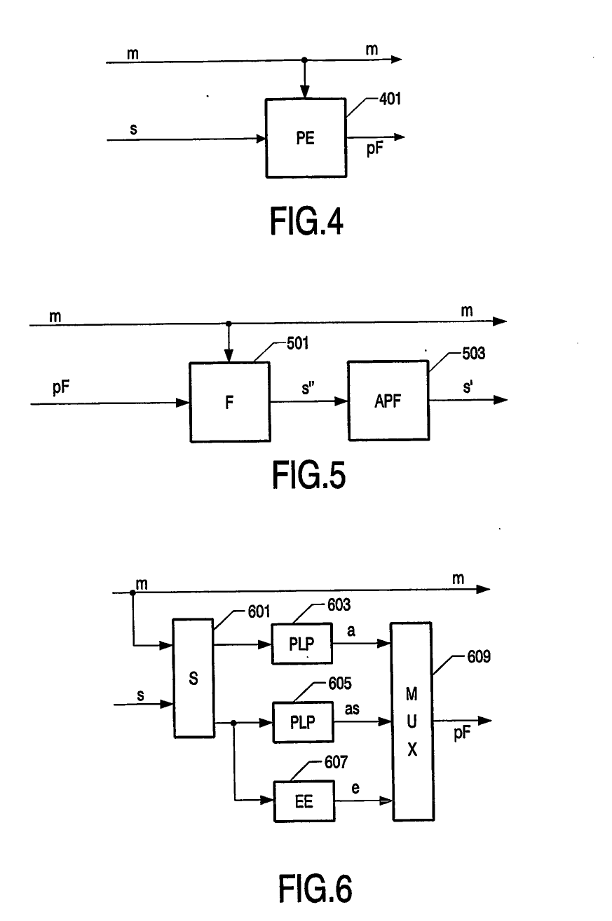

In FIG. 4, an embodiment of the general idea of the second step of an encoder, according to the present invention, is illustrated. The box 401 is the parameter extraction procedure. From the s signal and from the m signal filter characteristics are derived and parameters of the filter pF are the output. In particular, the box 401 estimates the parameters of a filter which captures the relation between the spectra of the main and the side signal. The parameter extraction procedure needs only to establish a filter giving rise to the desired spectral energy relation.

FIG. 5 illustrates an embodiment of the general idea of the decoder part for decoding the encoded m and s signal using the m signal and the parameters pF as input. The main signal m is filtered by a filter 501 using the parameters pF according to the present invention. The filter generates a first signal s″ where the spectral energy relation has been established. In the filter 502, being a time-invariant decorrelation filter (allpass filter or an approximation thereof), it is ensured that its output s′ is psycho-acoustically uncorrelated with m.

In the following, specific embodiments of the above described encoding of the m and the s signal and decoding to obtain m and the s′ are presented.

FIG. 6 shows a schematic view of an arrangement for the second step of encoding a stereo signal according to a first embodiment of the invention. In this embodiment, both the s and the m signal are initially segmented into overlapping frames. By performing this segmentation the encoding is performed on a smaller segment whereby the encoding can be performed on a stream of data. Further, a more accurate regeneration of the signals can be obtained when performing the encoding and decoding process on smaller segments. By using smaller segments, changes in relations can be followed.

The segmentation of both the m and the s signal is performed in the segmentation unit 601. Then in 603 linear prediction is performed on each segment of the m signal resulting in a set of prediction coefficients a. In 605 linear prediction is performed on each segment of the s signal resulting in a set of prediction coefficients as. Further, in 607, the energy e of each segment of the signal s is estimated. The prediction coefficients a, as and the estimated energy e is multiplexed in 609 to the set of transformation parameters pF. The m signal and the set of transformation parameters pF now represent the m and the s signal and can be used for regenerating a signal corresponding to the s signal in a decoder.

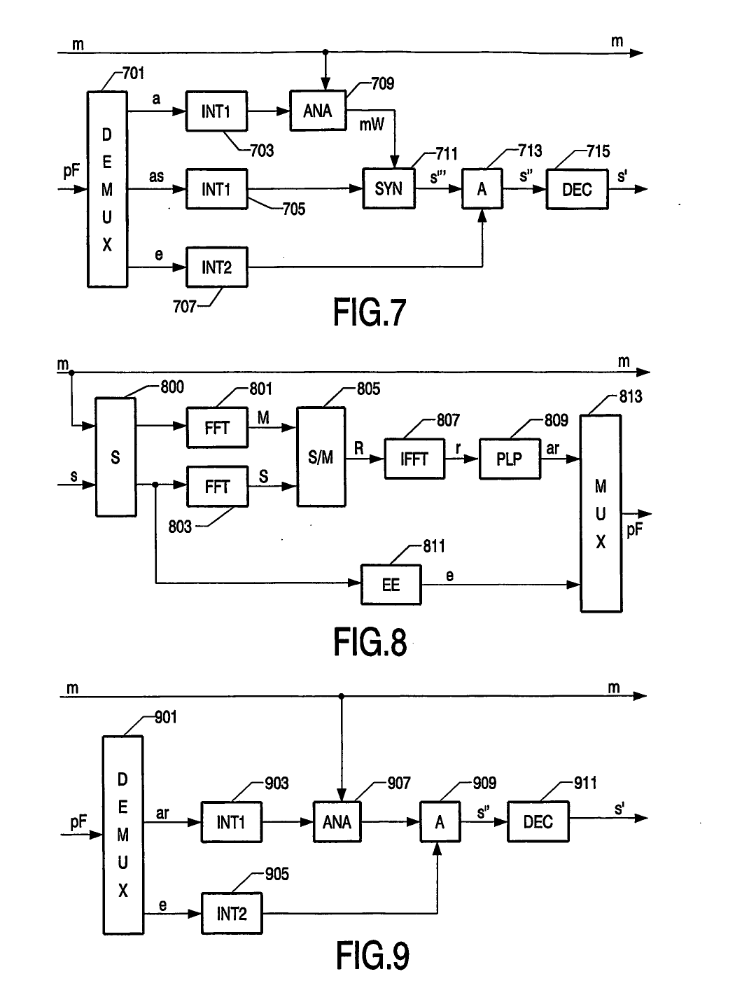

FIG. 7 shows a schematic view of an arrangement for decoding a stereo signal according to a first embodiment of the invention. The m signal and the transformation parameters pF are used as input to the decoder. In 701, the transformation parameters are demultiplexed to the prediction coefficients a and as and the estimated energy e. Then in 703 the prediction coefficients a are interpolated between subsequent frames such that in each segment prediction coefficients are available. In 705 and 707, a similar interpolation is performed on the prediction coefficients as and the estimated energy e. In 709, the m signal is whitened in a linear prediction analysis filter described by the prediction coefficients a, resulting in the whitened m signal mW. Next in 711, the output of the filter 709 mW is filtered by a linear prediction synthesis filter described by the prediction coefficients as based on the original s signal, the output of the synthesis filter being the signal s′″. Next in 713, attenuation is applied and it is ensured that the energy of the output s″ matches the energy e estimated on the original s signal. Finally, in 715 the signal s″ is filtered in a decorrelation filter or all-pass filter removing any correlation in a psycho acoustically sense between the generated output s′ and the m signal.

FIG. 8 shows a schematic view of an arrangement for the second step encoding a stereo signal according to a second embodiment of the invention. Firstly, in 800 the m and the s signal are segmented as described in connection with FIG. 6. Then in 801, the amplitude spectra M of the signal m are determined by performing a Fast Fourier transformation of the m signal. Similarly, in 803, the amplitude spectra S of the signal s is determined by performing a Fast Fourier transformation of the s signal. In 805, the ratio R=S/M is determined and in 807 an inverse Fast Fourier transformation is performed resulting in the signal r. In 809, linear prediction is performed on the r signal resulting in a set of prediction coefficients and in 811 the energy e of each segment of the signal s is estimated. The prediction coefficients ar and the estimated energy e is multiplexed in 813 to the set of transformation parameters pF. The m signal and the set of transformation parameters pF now represent the m and the s signal and can be used for regenerating a signal corresponding to the s signal in a decoder. As an alternative, the prediction coefficient ar could also be generated directly from the ratio signal R.

FIG. 9 shows a schematic view of an arrangement for decoding a stereo signal according to a second embodiment of the invention. The m signal and the transformation parameters pF are used as input to the decoder. In 901, the transformation parameters are demultiplexed to the prediction coefficients ar and the estimated energy e. Then in 903, the prediction coefficients ar are interpolated between subsequent frames such that in each segment prediction coefficients are available. In 905, a similar interpolation is performed on the estimated energy e. In 907, the m signal is filtered in a linear prediction analysis filter described by the prediction coefficients ar. Next in 909, attenuation is applied and it is ensured that the energy of the output s″ matches the energy e estimated on the original s signal. Finally in 911, the signal s″ is filtered in a decorrelation filter or all-pass filter removing any correlation in a psycho acoustical sense between the generated output s′ and the m signal. In an alternative embodiment of the above, the filtering order can be reversed. Further, if R is defined as S/M the linear prediction analysis filter has to be used in the decoder. Alternatively, if R were defined as M/S then a linear prediction synthesis filter had to be used in the decoder.

To make the synthesis filters simpler (i.e. of lower order) it may be convenient to encapsulate the decorrelation filter in the prediction coefficients. The filter described by the prediction coefficients performs a form of psycho-acoustic decorrelation which, consequently, does not need to be done by the decorrelation filter anymore. However, this encapsulation has to be done in the encoder and the total filter (spectral shaping and decorrelation) has to be transmitted. This will typically lead to an increased bit rate.

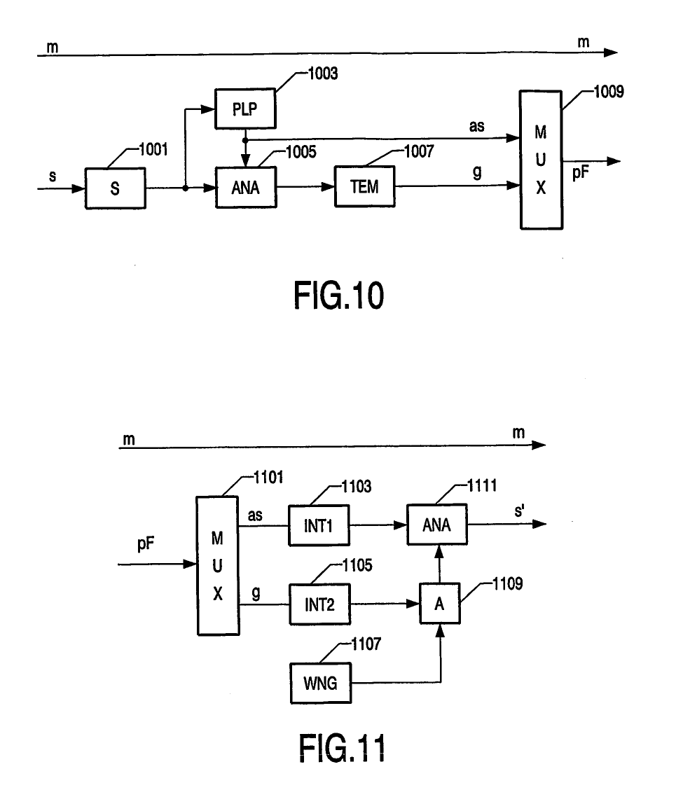

FIG. 10 shows a schematic view of an arrangement for the second step of encoding a stereo signal according to a third embodiment of the invention. First in 1001, the s signal is segmented as described in connection with FIG. 6. In 1003, linear prediction is performed on each segment of the s signal resulting in a set of prediction coefficients as. In 1005, the s signal is filtered in a linear prediction analysis filter described by the prediction coefficients as and in 1007 the temporal envelope g is determined of each segment. The temporal envelope could e.g. be determined by using more than one energy measurement per segment or by applying temporal noise shaping. The prediction coefficients as and the temporal envelope g is multiplexed in 1009 to the set of transformation parameters pF. The m signal and the set of transformation parameters pF now represent the m and the s signal and can be used for regenerating a signal corresponding to the s signal in a decoder.

FIG. 11 shows a schematic view of an arrangement for decoding a stereo signal according to the third embodiment of the invention. The m signal and the transformation parameters pF are used as input to the decoder. In 1101, the transformation parameters are demultiplexed to the prediction coefficients as the temporal envelope g. Then in 1103, the prediction coefficients as are interpolated between subsequent segments such that in each segment prediction coefficients are available. In 1105, a similar interpolation is performed on the temporal envelope g. In 1107, a white noise generator generates a white sequence. Then in 1109, the temporal envelope is applied in 1109 and finally, in 1111, the white sequence is filtered in a linear analysis filter described by the prediction coefficients as resulting in the output s′.

For audio and speech coding purposes, it is advantageous to use linear prediction filters with a behaviour that is in some way reminiscent of auditory filters. Examples of such filters are Kautz filters, Laguerre filters and Gamma-tone filters and are e.g. described in WO2002089116.

It is understood that a skilled person may adapt the above embodiments, e.g. by adding or removing features or by combining features of the above embodiments. It is further noted that the invention is not limited to stereophonic signals, but may also be applied to other multi-channel input signals having two or more input channels. Examples of such multi-channel signals include signals received from a Digital Versatile Disc (DVD) or a Super Audio Compact Disc, etc. In this more general case, a principal component signal y and one or more residual signals r may still be generated according to the invention. The number of residual signals transmitted depends on the number of channels and the desired bit rate, as higher order residuals may be omitted without significantly degrading the signal quality.

In general, it is an advantage of the invention that bit-rate allocation may be adaptively varied, thereby allowing graceful degradation. For example, if the communication channel momentarily only allows a reduced bit rate to be transmitted, e.g. due to increased network traffic, noise, or the like, the bit rate of the transmitted signal may be reduced without significantly degrading the perceptible quality of the signal. For example, in the case of a stationary sound source as discussed above, the bit rate may be reduced by a factor of approximately two without significantly degrading the signal quality which corresponds to transmitting a single channel instead of two.

It is noted that the above arrangements may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It should be noted that the above-mentioned embodiments illustrate rather than limit the invention and that those skilled in the art will be able to design many alternative embodiments without departing from the scope of the appended claims. In the claims any reference signs placed between parentheses shall not be construed as limiting the claim. The word ‘comprising’ does not exclude the presence of other elements or steps than those listed in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding a main and a side signal, where at least said main and side signal represent a multichannel audio signal, where the main and side signal have the properties that the relation between the power spectral energies of said main and side signal is intact per psycho-acoustical band and where said side signal is psycho acoustically uncorrelated with the main signal. The method of encoding the main and the side signal comprises the steps of:
transforming the side signal by a predetermined transformation into a set of transformations parameters, said parameters being adapted for reproducing a third signal corresponding to the side signal and having said properties of the side signal,
representing the multichannel signal at least by said main signal and said transformation parameters.

2. A method according to claim 1, wherein the predetermined transformation comprises the step of:
generating a set of transformation parameters from the main and the side signal, where said transformation parameters define the relationship between the spectra of the main and the side signal.

3. A method according to claim 1, wherein the step of generating the transformation parameters comprises the steps of:
performing linear prediction on both said main signal and said side signal resulting in two sets of prediction coefficients, a first set comprising coefficients corresponding to the main signal and a second set comprising coefficients corresponding to the side signal,
determining the energy of the side signal, said transformation parameters comprising said prediction coefficients and said determined energy.

4. A method according to claim 1, wherein the step of generating the transformation parameters comprises the steps of:
determining the amplitude spectra of the main and the side signal,
determining the ratios between the determined amplitude spectras of the main and the side signal,
generating prediction coefficients by using information based on the determined ratios as input to a prediction system,
determining the energy of the side signal,
said transformation parameters comprising said prediction coefficients and said determined energy.

5. A method according to claim 1, wherein the step of generating the transformation parameters comprises the steps of:
performing linear prediction on the side signal resulting in a set of prediction coefficients comprising coefficients corresponding to the side signal,
determining the temporal envelope for the side signal, said transformation parameters comprising said prediction coefficients and said determined temporal envelope.

6. A method according to claim 1, wherein transforming the side signal into a set of transformation parameters is performed on overlapping segments of at least the side signal and by determining transformation parameters corresponding to each segment.

7. A method of decoding main and side signal information, where at least said main and side signal represent a multichannel audio signal, the main and side signal have the properties that the relation between the power spectral energies of said main and side signal is intact per psycho-acoustical band and where said side signal is psycho acoustically uncorrelated with the main signal, the method comprises the steps of:
receiving a main signal and a set of transformation parameters, said transformation parameters being adapted for reproducing a third signal corresponding to the side signal and having the same properties as the side signal,
generating the third signal having the said properties of the side signal by using said transformation parameters for inversely performing the predetermined transformation.

8. A method according to claim 7, wherein the step of generating the third signal comprises the steps of:
generating a white noise sequence,
generating a first signal by filtering the white noise sequence in a linear prediction filter defined by the prediction coefficient corresponding to the side signal, said prediction coefficients comprised in the received transformation parameters,
attenuating the second signal until the energy of the second signal corresponds to the determined energy of the side signal, said determined energy being comprised in said received transformation parameters.

9. A method according to claim 7, wherein the step of generating the third signal comprises the steps of:
generating a temporal signal in which the spectral energy relation between the temporal signal and the main signal corresponds to the spectral energy relation between the main signal and the side signal, said temporal signal being generated by filtering the main signal using the transformation parameters as filter parameters,
filtering the temporal signal ensuring that the output signal is psycho acoustically uncorrelated with the main signal.

10. A method according to claim 9, wherein the step of generating the temporal signal comprises the steps of:
generating a first signal by filtering the main signal in a linear prediction analysis filter defined by the prediction coefficient corresponding to the main signal, said prediction coefficients comprised in the received transformation parameters,
generating a second signal by filtering said first signal in a linear prediction synthesis filter defined by the prediction coefficients corresponding to the side signal comprised in the received transformation parameters,
attenuating the second signal until the energy of the signal corresponds to the determined energy of the side signal, said determined energy being comprised in said received transformation parameters.

11. A method according to claim 9, wherein the step of generating the temporal signal comprises the steps of:
generating a first signal by filtering the main signal in a linear prediction filter defined by the prediction coefficient, where said prediction coefficients are comprised in the transformation parameters, said prediction coefficients having been generated by
determining the ratios between the determined amplitude spectras of the main and the side signal,
performing an inverse Fourier transformation of the determined ratios,
using the result of the inverse Fourier transformation as input to a prediction system.
attenuating the second signal until the energy of the signal corresponds to the determined energy of the side signal, said determined energy being comprised in said transformation parameters.
said transformation parameters comprising said prediction coefficients and said determined energy.

12. A method according to claim 7, wherein when the transformation parameters has been generated corresponding to specific segments, then the step of generating the third signal having the same properties as the side is performed by initially interpolating transformation parameters between the specific segments.

13. An arrangement for encoding a main and a side signal, where at least said main and side signal represent a multichannel audio signal, where the main and side signal have the properties that the relation between the power spectral energies of said main and side signal is intact per psycho-acoustical band and where said side signal is psycho acoustically uncorrelated with the main signal, the arrangement comprising:
first processing means for transforming the side signal by a predetermined transformation into a set of transformation parameters, said parameters being adapted for reproducing a third signal corresponding to the side signal and having the same properties as the side signal,
second processing means adapted to represent the multichannel signal at least by said main signal and said transformation parameters.

14. An arrangement for decoding main and side signal information, where at least said main and side signal represent a multichannel audio signal, the main and the side signal have the properties that the relation between the power spectral energies of said main and side signal is intact per psycho-acoustical band and where said side signal is psycho acoustically uncorrelated with the main signal, the method comprises the steps of:
receiving means for receiving a main signal and a set of transformations parameters, said transformation parameters being adapted for reproducing a third signal corresponding to the side signal and having the same properties as the side signal,
processing means for generating the third signal having the same properties as the secondary signal by using said transformation parameters for inversely performing the predetermined transformation.

15. A data signal including multichannel signal information, the data signal being encoded by a method of encoding according to claim 1.

16. A computer-readable medium comprising a data record indicative of multichannel signal information encoded by a method of encoding according to claim 1.

17. A device for communicating a multichannel signal, the device comprises an arrangement for encoding a main and a side signal, where at least said main and side signal represent a multichannel audio signal, where the main and side signal have the properties that the relation between the power spectral energies of said main and side signal is intact per psycho-acoustical band and where said side signal is psycho acoustically uncorrelated with the main signal, the arrangement comprising:
first processing means for transforming the side signal by a predetermined transformation into a set of transformation parameters, said parameters being adapted for reproducing a third signal corresponding to the side signal and having the same properties as the side signal,
second processing means adapted to represent the multichannel signal at least by said main signal and said transformation parameters.
